(19) United States
(12) Patent Application Publication
(10) Pub. No.: US 2004/0225552 A1
(43) Pub. Date: Nov. 11, 2004

(54) Process control system

(75) Inventors: Hiroshi Ikeda, Tokyo (JP); Masataka Hasegawa, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA PHOTO IMAGING, INC., Tokyo (JP)

(21) Appl. No.: 10/825,982

(22) Filed: Apr. 16, 2004

(30) Foreign Application Priority Data
Apr. 24, 2003 (JP) JP2003-119754
Sep. 17, 2003 (JP) JP2003-323962

(51) Int. Cl. G06F 17/60

(52) U.S. Cl. 705/9; 700/95

(57) ABSTRACT

A process control system, including:

a first place where a customer places an order to produce an product from a material, by explaining order information which relates to a production process of the product;

a first conveyance device to convey the material from the first place to the second place;

a second conveyance device to convey order information from the first place to the second place;

a second place where the product is produced from the material, based on order information;

wherein the material and order information are separately utilized to produce the product at the second place.

### BACKGROUND OF THE INVENTION

The present invention relates to a process control system, and in particular, to a process control system wherein the amount of materials to be processed in a production processing site is searched beforehand, the working time of the equipment is studied, and the necessary manpower is reserved so that the production is performed most effectively, and further,

the present invention relates to a process control method and a process control program, and specifically to a process control method and a process control program to simulate the production process of photographic products.

In the photo-finishing business world in the past, photo-finishing order of a film or image data is received from the customer at a photo-shop or a convenience store (which is a first place), and the films or the image data are forwarded to a photo-finishing site (which is a second place such as a photo-finishing laboratory) to be processed in a concentrated manner.

In this case, the photo-finishing laboratory finally can plan for the amount (which means working time, or production cost, for example) of film or image data to be processed, when the photo-finishing laboratory has received all of the film or the image data. The reasonable delivery time can generally be determined beforehand, which is the time interval between receipt time of the film or the image data from the customer and its return time after the photo-finishing. The amount of film or image data to be photo-finished is subject to the seasonal events (which means significant cultural and family events) or the weather, whereby the photo-finishing laboratory can realistically determine a production schedule, based on seasonal prediction or the record of received orders in the past, and secure the processing equipment and man power in order to keep the scheduled delivery time.

However, when the amount of orders accepted is far beyond the prediction, most of the photo-finishing laboratories manage the work in the following manner, that is, if the accepted orders are more than the prediction, the photo-finishing laboratory takes steps to immediately increase the manpower, and if the accepted orders are less than the prediction, it releases the scheduled manpower.

Further, due to the popularization of The Internet, the orders through the Web or e-mail using digital data, have increased. In this case, the processing schedule of the image data is finally determined when the image data has been accepted by a processing terminal installed in the same place where the photo-finishing is performed. Such a production system as mentioned above is not different from the conventional system, where order placement and reception are not improved, which is a drawback.

Patent Document 1 discloses that text data showing the specific order and image data are included in an order receiving file about a specific order. In this case, since a single file including not only text data showing the specific order but also image data, is formed, the order file is so large that the communication time is very long, and further, the production schedule must be determined only after the order file has been obtained, which again exhibits little difference in drawbacks from the conventional system.

(Patent Document 1) Japanese Patent Publication Open to Public Inspection No. 2002-359713.

Additionally, in on-demand-production type systems which produce products upon receipt of orders, for every order, equipment and operators are assigned. As a result, when a plurality of orders is continually received, it occasionally occurs that orders are not efficiently processed due to the fact that it is not possible to use equipment until the preceding order is completely processed. Specifically, in cases of production related to photographic products, even though orders are different, it frequently occurs that it is necessary to use overlapping production processes. Consequently problems result in which it is not possible to efficiently use equipment nor an operator.

As a result, when a plurality of orders which requires the use of overlapping production processes is processed, a method is employed in which after setting up a production process after integrating a plurality of orders, equipment and operators are assigned to each of the production processes. By employing such a method, even when a plurality of orders is received, it is possible to collectively process overlapping production processes, whereby it is possible to more efficiently use equipment and operators. This method is one which is commonly employed in the production of products and services related to photography. A method for preparing school photos based on such a concept is described in Patent Document 2.

(Patent Document 2)

Japanese Patent Publication Open to Public Inspection No. 8-160541 (pages 16-24 and FIG. 1) In the aforementioned process control method, generally, when orders are confirmed, necessary equipment for production of products is decided, and operators are assigned based on the previously specified order. In such a case, when a production process results in neither a difference in processing time nor contents of the production process by any of the operators, the production process namely is dependent on equipment and is not dependent on operators, no problems occur by assigning operators without considering the specified order. However, when a production process results in difference in processing time and contents of processing, the production process namely is not dependent on equipment but on operators, then it is not possible to efficiently process orders without considering the assignment of operators.

Description will now be made with reference to an example of the order of photographic products. In the case of a processing service in which photographic film strips are developed and photographic prints are produced, since developing film strips and producing photographic prints are automatically conducted employing only equipment, the processing time and processing contents do not differ even though any of the operators performs any of the production processes. On the other hand, in the case of a service in which photo postcards are produced employing images provided from individuals, operations such as layout of images and text, and designing are included. It is not possible to automate such operations, and operator skill is required. Consequently, it is required to assign an operator possessing the specified skills for the production processes.

When time required for production of products varies due to assignment of varied skill operators, in order to estimate the production time, a method is effective in which individual production processes are simulated. However, in conventional process control devices, it was not possible to assign operators while considering their skills. Consequently, when products were practically produced based on a production schedule made by the method obtained by the aforementioned simulation, problems occurred in which processing is delayed in specific production processes, and the finished quality of products fluctuates.

Further, when layout processing and design processing are included as described in the preparation of photo postcards, evaluation for products processed by a specified operator occasionally differs depending on the customer. In order to enhance the degree of customer satisfaction, it is also required to assign operators by taking into account their relationship with each customer.

### SUMMARY OF THE INVENTION

The objective of the present invention is to provide a process control system, wherein an amount of a product to be processed at a production processing site is researched beforehand, the working time of the equipment is studied, and the necessary manpower is reserved so that the production is performed very effectively,

still further, the objective of the present invention is to provide a process control method and a process control program which adequately simulate the overall production process of a product and accurately calculate production time, even though orders include operator dependent production processes.

The objective of the present invention is attained by the structures described below.

Structure 1.

In a process control system wherein a material is processed based on order information of the material, the material and its order information can be separately used.

Structure 2.

In a process control system wherein a material is processed based on order information of the material, its order information can be used before the material comes into a condition in which the product is produced from the material.

Structure 3.

The process control system in Structure 1 or 2, wherein the material is film, photographic paper, or a medium on which digital data have been recorded.

Structure 4.

The process control system in Structure 1, 2 or 3, wherein order information includes at least one of (1) the product, (2) the number of the product, (3) information to identify the material to be processed, in order to produce the product, (4) customer information, (5) photo-shop information, and (6) delivery time information.

Structure 5.

A process control method, including at least the steps of:

storing operator assigning information in which, for each customer of a product, the production process to produce the product is assigned to an operator who performs processing of each of the production processes;

inputting order information which includes information to identify the customer, as well as information to identify the product; and

assigning an operator for each of the production processes which have been set based on the product identified by the order information with reference to the operator assigning information with reference to the customer, identified by the order information.

Structure 6.

A process control method, including at least the steps of:

storing operator assigning information in which, for each customer of a product, the production process to produce the product is assigned to an operator who performs processing of each of the production processes, as well as processing time assigning information in which necessary time to perform processing of each of the production processes is assigned to each operator of the production process;

inputting order information which includes information to identify the customer, as well as information to identify the product;

assigning an operator for each of the production processes which have been set based on the product identified by the order information with reference to the operator assigning information which corresponds to the customer, identified by the order information;

calculating necessary production time to produce the product while extracting the processing time of each of the production processes and totaling the processing time with reference to the processing time assigning information; and

outputting the overall production time.

Structure 7.

A process control method including at least the steps of:

storing dependence assigning information which assigns production process which produce a product to dependence on whether the processing time of production is dependent on an equipment or the operator;

inputting order information which includes information to identify the customer of the product, as well as information to identify the product;

judging whether the processing time of each of the production processes, which have been set based on the product identified by the order information, is dependent on equipment or an operator; and

assigning an operator for each of the production processes which have been set based on the product identified by the order information.

Structure 8.

A process control method including at least the steps of:

storing dependence assigning information which assigns dependence on whether the processing time of production processes and each production process which produce a product is dependent on equipment or an operator, as well as processing time assigning information which assigns the processing time to the production process; inputting order information which includes information to identify the customer of the product, as well as information to identify the product;

judging whether the processing time of each of the production processes, which have been set based on the product identified by the order information, is dependent on equipment or an operator with reference to the dependence assigning information;

assigning an operator for each of the production processes, which have been set based on the product identified by the order information, with reference to results of the judgment;

calculating the necessary production time to produce the product while extracting the processing time which is set based on the processing capacity of the equipment in the case in which the processing time is dependent on equipment, and extracting the processing time which is set based on the processing capacity of a typical operator in the case in which the processing time is dependent on the operator with reference to the processing time assigning information and thereby totaling the processing time; and

outputting the production time.

Structure 9.

The process control method, described in any one of claims 5-8, wherein in the process control method described in any one of claims 5-8, either the operator assigning information or dependence assigning information is set based on the skill of the operator or the relationship between the customer and the operator.

Structure 10.

A process control program wherein a computer is allowed to function as at least the means of:

inputting order information which includes information to identify a customer of a product, as well as information to identify the product; and

assigning an operator for each of the production processes which have been set based on the product identified by the order information with reference to operator assigning information which assigns an operator to each of the production processes to produce the product, which has been stored for each of the customers.

Structure 11.

A process control program wherein a computer is allowed to function as at least the means of:

inputting order information which includes information to identify a customer of a product, as well as information to identify the product;

assigning an operator for each of the production processes which have been set based on the product identified by the order information with reference to operator assigning information which assigns an operator to each of the production processes to produce the product which has been stored for each of the customers;

calculating necessary production time to produce the product while extracting the processing time of each of the production processes with reference to previously stored processing time assigning information which assigns an operator to the necessary time to process each of the production processes and totaling the production processing times; and

outputting the production time.

Structure 12.

A process control program wherein a computer is allowed to function as at least the means of:

inputting order information which includes information to identify a customer of a product, as well as information to identify the product; judging whether the processing time of each of the production processes, which have been set based on the product identified by the order information, is dependent on equipment or an operator, with reference to the previously stored dependence assigning information which assigns each production process which produce the product to dependence on whether the processing time of production processes is dependent on the equipment or the operator; and assigning an operator for each of the production processes which have been set based on the product identified by the order information with reference to results of the judgment.

Structure 13.

A process control program wherein a computer is allowed to function as at least the means of:

inputting order information which includes information to identify a customer of a product, as well as information to identify the product;

judging whether the processing time of each of the production processes, which have been set based on the product identified by the order information, is dependent on equipment or an operator, with reference to the previously stored dependence assigning information which assigns each production process which produce the product to dependence on whether the processing time of production processes is dependent on the equipment or the operator;

assigning an operator for each of the production processes which have been set based on the product identified by the order information with reference to the judging results;

calculating the necessary production time to produce the product while extracting the processing time which is set based on the processing capacity of the equipment in the case in which the processing time is dependent on equipment, and extracting the processing time which is set based on the processing capacity of a typical operator in the case in which the processing time is dependent on an operator with reference to the previously stored processing time assigning information which assigns the processing time to the production process and totaling the individual processing times; and

outputting the production time.

Structure 14.

In the process control program described in any one of claims 10-13, stored in a process control apparatus, which simulates the production process of products, information which assigns an operator for a production process which is set for each of the customers, information which assigns the processing time of an individual production process to an operator, and information which assigns equipment dependence or human dependence of an individual production process to the production process; with reference to these parts of assigning information, necessary time to produce a product is calculated while appropriately assigning an operator for each of the production processes; and by taking into account the skill of operators, the relationship between the customer and the operator, and production process dependence (equipment dependence or human dependence), even in cases in which a production process which necessitates specific skill of an operator is included as is seen in an order of a photographic product, it is possible to appropriately simulate the production process of products to correctly calculate the production time, whereby it is possible to prepare a precise production schedule, and accurately calculate the production time.

### BRIEF DESCRIPTION OF THE DRAWINGS

FIG. 1 is a block diagram showing an example of a process control system of the present invention.

FIG. 2 is a drawing explaining a time lag in the arrival times of order information and material.

FIG. 3 is a block diagram showing an example of a process control system of the present invention.

FIG. 4 is a drawing explaining a time lag in the arrival times of order information and material.

FIG. 5 is a block diagram showing an example of a process control system of the present invention.

FIG. 6 is a drawing explaining a time lag in the arrival times of order information and material.

FIG. 7 is a block diagram showing an example of a process control system of the present invention.

FIG. 8 is a drawing explaining a time lag in the arrival times of order information and material.

FIG. 9 is a block diagram showing an example of a process control system of the present invention.

FIG. 10 is a drawing explaining a time lag in the arrival times of order information and material.

FIG. 11 is a block diagram showing an example of a process control system of the present invention.

FIG. 12 is a block diagram showing the constitution of a process control apparatus related to embodiment 2-1 of the present invention.

FIG. 13 is a flow chart showing steps of a process control method using a process control system related to embodiment 2-1 of the present invention.

FIG. 14 is a view showing an example of a constitution of a table (being an operator assigning table) which is referred to in the process control method related to embodiment 2-1 of the present invention.

FIG. 15 is a view showing an example of a constitution of a table (being a processing time assigning table) which is referred to in the process control method related to embodiment 2-1 of the present invention.

FIG. 16 is a block diagram showing the constitution of a process control apparatus related to embodiment 2-2 of the present invention.

FIG. 17 is a flow chart showing steps of a process control method employing a process control system related to embodiment 2-2 of the present invention.

FIG. 18 is a view showing an example of a constitution of a table (being a dependence assigning table) which is referred to in the process control method related to embodiment 2-2 of the present invention.

FIG. 19 is a view showing an example of a constitution of a table (being a processing time assigning table) which is referred to in the process control method related to embodiment 2-1 of the present invention.

### DETAILED DESCRIPTION OF THE PREFERRED EMBODIMENT

The embodiments of the present invention will now be described.

Embodiments 1-1 through 1-10 relate to the process wherein a customer orders the products (which are color prints, for example) from the material (which is a color film, for example) and provides order information (which are: customer name, print size and number of prints, etc.) at the shop (which is a first place), after which the production processing section (which is a second place) accepts the material sent by a first conveyance device and order information sent by a second conveyance device.

(Embodiment 1-1)

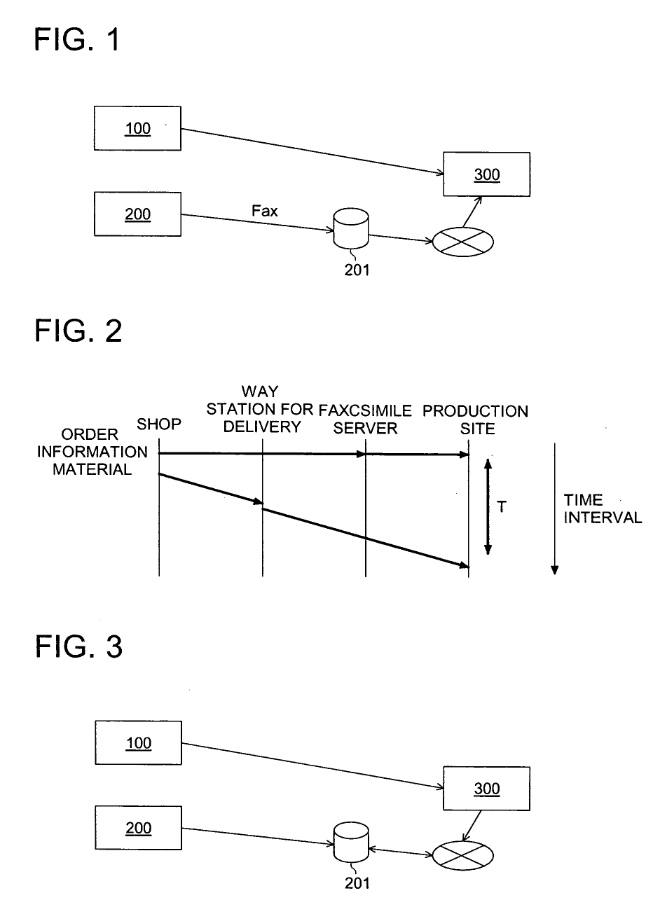

FIG. 1 is a block diagram of embodiment 1-1, where numeral 100 is a material to be processed for a customer, numeral 200 is order information, and numeral 300 is a production processing section (which is a second place).

Material 100 to be processed for the customer includes negative film, positive film, photographic paper, printed matter and various other media (for example, FD, MO, CD-R, DVD-R, SM, CF, PC card, MMC, or SDC) on which digital data have been recorded.

Order information 200 includes:

(1) the products including; various sized products (89×131 mm, 102×152 mm, 203×254 mm, or 254×304 mm) such as a print, calendar, post card, identification photo, group photo, snap-shot, signature/stamps, badge, cards, photo album, DM card, index print, CD, DVD, figure, book, panel, poster, tile, and coaster, etc;

(2) the number of the product, including the number of sheets, the number of the copies;

(3) information such as plural digit numbers, or plural digit alphanumeric numbers, to identify the material to produce the products;

(4) customer information, including the customer's name, telephone number, e-mail address, street address, latitude and longitude of residence, cell-phone number, facsimile number, age, birth date, blood group, names of family members, ages of family members, birth date of family members, and blood group of family members, etc;

(5) shop information, information concerning a shop which receives the order from a customer, including; the name of the shop, telephone number, name of receiving clerk, address of shop, facsimile number, cell phone number of clerk, e-mail address of shop, URL (being Uniform Resource Locator) of shop, latitude and longitude of shop, non-business day of the shop, business hours of the shop, scheduled delivery and collection times, etc;

(6) delivery information, including; delivery time by a producer, and delivery time which a customer expects; and

(7) other information, including; detailed instruction of color and density, cropping area, instruction of each material, mailing address of direct mail, the number of lots to be printed on the product, advertisement information to be printed on the product, order of music, and order for synchronizing image and music on a CD, etc.

In the case shown in FIG. 1, order information 200 is sent from the shop (which is a first place) to FAX server 201 via facsimile (which is a first conveyance device), and is transformed to digital image signals by FAX server 201 which is installed between the two, and is then sent to a section where production processing section 300 (which is a second place) can use order information 200. It is preferable to also transform order information 200 from image data into the character data by combining OCR with FAX server 201. Production processing section 300 sends order information 200 to the section where order information 200 can be used, by e-mail (SMTP protocol), Web mail (http protocol), and ftp (ftp protocol) which are second conveyance devices.

A report including order information 200 for material 100 of the customer can be facsimiled from a section (a shop at which the customer places an order, or a way station of a collection delivery service) which is before production processing section 300, and is transformed to digital image signals by FAX server 201 which is installed on the way of the communication, and is then sent by production processing section 300 to a section at which order information 200 can be used.

Material 100 to be processed, ordered by the customer, is sent from the shop (which is a first place) to production processing section 300 (which is a second place) via a collection delivery service (which is a first conveyance device) or the communication. If material 100 to be processed is digitalized, it is preferable to send it using electronic communication (Internet, for example).

In prior art, when both order information 200 and material 100 are pared at the production processing section 300 (which is a second place such as a production site, for example), they can finally be under a using condition.

However, in the present invention, order information 200 and material 100 can be separately used at production processing section 300 (such as a production site, for example).

As shown in FIG. 2, there is time lag T between the time interval during which order information 200 is sent from the shop to the production processing section (which is a production site) through a FAX server, and the time interval during which material 100 is sent from the shop to the production processing section 300 (being a production site) through a way station for delivery. Within time T, a production schedule can be set up, and further, personal distribution and the allocation of the production equipment can also be scheduled.

Further, as shown in FIG. 3, it is also possible to request (call for) the electronic data by accessing FAX server 201 from production processing section 300 (which is a production site). As a means to access FAX server 201 from production processing section 300 (which is a production site), may be a manual method or an automatic method, of which the automatic method is more preferable.

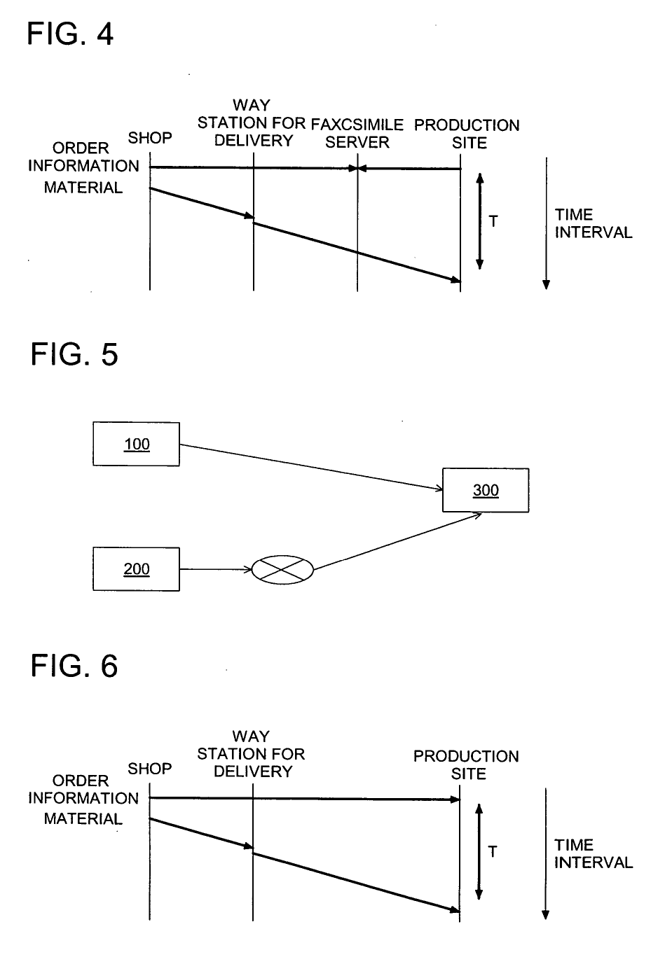

In this case, as shown in FIG. 4, there is also time lag T between the time interval during which order information 200 is sent from the shop to FAX server, and is received by the production processing section 300 (which is a production site) by requesting (calling for) the FAX server, and the time interval during which material 100 is sent from the shop to the production processing section 300 (a production site) through various way stations of a service. Within time T, production schedule can be scheduled, and further, personal distribution and the allocation of the production equipment can also be scheduled.

(Embodiment 1-2)

FIG. 5 shows a block diagram of embodiment 1-2. In embodiment 1-2, in the case when image data (being material 100) are taken by a digital still camera, order information 200 of the image data exist as digital data. Therefore, production processing section 300 sends order information 200 to the section where order information 200 can be used, via e-mail (SMTP protocol), Web mail (http protocol), and ftp (ftp protocol) which are second conveyance devices, while order information is sent by facsimile (which is a second conveyance device) as in the case of embodiment 1-1. Further, digital data, which are obtained by scanning order information instead of DSC, can also be sent to a section at which order information 200 can be used.

In the past, when both order information 200 and material 100 are paired in production processing section 300 (such as a production site, for example), they can finally be in a usable condition.

However, in the present invention, order information 200 and material 100 can be separately used in production processing section 300 (such as a production site, for example).

As shown in FIG. 6, time lag T exists between the time interval during which order information 200 is sent from the shop to the production processing section (which is a production site), and the time interval during which material 100 is sent from the shop to the production processing section 300 (being a production site) through a way station for delivery. Within time T, a production schedule can be set up, and further, personnel distribution and allocation of production equipment can also be scheduled.

In case that order information 200 is digitalized, and which is on a site to which production processing section 300 can be accessed through communication, it is possible to be accessed from production processing section 300 to order information 200, and to obtain electronic data. A means of production processing section 300 to access order information 200, may be a manual method or an automatic method, of which the automatic method is more preferable.

(Embodiment 1-3)

In the case of embodiment 1-3, order information 200 is formed to be digitalized character information, whereby production processing section 300 can send order information 200 by e-mail (SMTP protocol), Web mail (http protocol), and ftp (ftp protocol) to the section where order information 200 can be used, while order information 200 is sent using photographed image taken with a digital still camera in embodiment 1-2. It is also possible to input character information by software program such as a text editor.

(Embodiment 1-4)

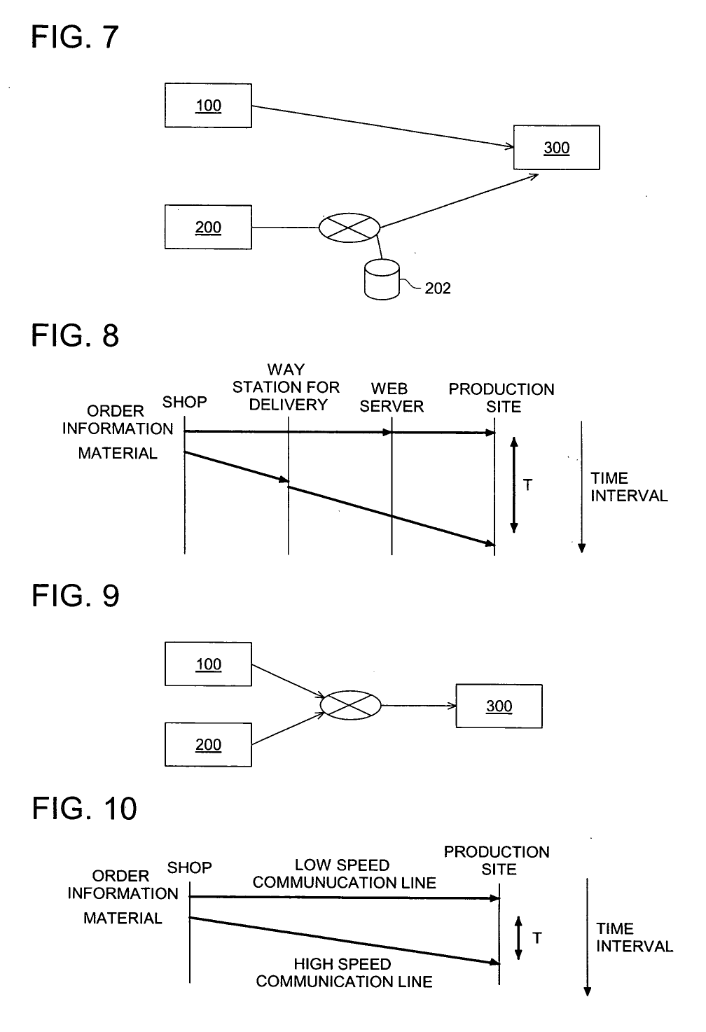

FIG. 7 is a block diagram of embodiment 1-4. In the case of embodiment 1-4, character information of order information 200 is inputted on web server 202 screen to be digitalized, and production processing section 300 sends order information 200 to the site where order information in that form can be used, though order information 200 is formed to digitalized character information, and is sent via e-mail in embodiment 1-3. Production processing section 300 sends order information 200 to the site where order information 200 can be used, in ways such as e-mail (SMTP protocol), Web mail (http protocol), and ftp (ftp protocol). Character information can be processed via CGI on a Web server.

In this embodiment, as shown in FIG. 8, time lag T exists between the time interval during which order information 200 is sent from the shop to production processing section 300 (which is a production site) through a FAX server 202, and the time interval during which material 100 is sent from the shop to production processing section 300 (being a production site) via a way station for delivery. Within time T, a production schedule can be set up, and further, personnel distribution and allocation of the production equipment can also be scheduled.

In the above embodiment, it is also possible that production processing section 300 obtains the digitalized character information of order information 200 by accessing Web server 202.

(Embodiment 1-5)

FIG. 9 is a block diagram of embodiment 1-5. Since both order information 200 and material 100 are formed of digital data, production processing section 300 sends order information 200 and material 100 to the site where both order information 200 and material 100 can be used, through the respective lines.

It is preferable that order information 200 is sent via a public circuit or ISDN which are low speed, because the amount of data of order information 200 is relatively small, while material 100 is sent by ADSL or optical fiber line which are high speed, because the amount of data of material 100 is relatively large. Though an ADSL or optical fiber line is used, it may take a long time to transmit the data, when the amount of information of material 100 is very large.

In this embodiment, as shown in FIG. 10, time lag T exists between the time interval during which order information 200 is sent from the shop to production processing section 300 (which is a production site) through a low speed line (ISDN, for example), and the time interval during which material 100 is sent from the shop to production processing section 300 (being a production site) through a high speed line (ADSL, for example). Within time T, a production schedule can be set up, and further, personnel distribution and allocation of the production equipment can also be scheduled.

(Embodiment 1-6)

A network communication, shown in FIG. 9, can be used for this embodiment. According to this embodiment, in the case that both order information 200 and material 100 are formed of digital data, production processing section 300 sends both order information 200 and material 100 via the respective protocols to the site where both can be used.

Order information 200 is sent via e-mail (smtp protocol), because the amount of data of order information 200 is relatively small, while material 100 is sent by ftp protocol which is exclusive for a file transfer, because the amount of data of material 100 is relatively large.

(Embodiment 1-7)

A communication network, shown in FIG. 9, can be used for this embodiment. According to this embodiment, in the case that both order information 200 and material 100 are formed of digitalized data, order information 200 includes personal data, and thereby order information 200 is encrypted, while material 100 is not encrypted, and production processing section 300 sends both order information 200 and material 100 to the site where both are to be used. Methods of encryption of digital data include DES, RSA, ECC, RC4 or RC5. Because encryption of digital data is a very expensive computer process, it is preferable that the encryption is conducted in a minimal range, after which production processing section 300 sends encrypted data to the site where the encrypted data are to be used.

(Embodiment 1-8)

The communication network, shown in FIG. 9, can be used for this embodiment. According to this embodiment, in the case that both order information 200 and material 100 are digitized data, after encryption, production processing section 300 sends them to the site where both order information 200 and material 100 are to be used. Methods of encryption of the digital data include DES, RSA, ECC, RC4 or RC5. Encryption of digital data is a very expensive computor process, however, in order to protect confidentiality, it is preferable that both order information 200 and material 100 are encrypted.

(Embodiment 1-9)

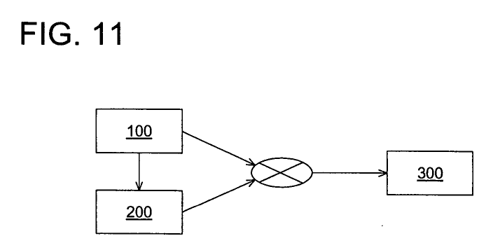

FIG. 11 shows a block diagram of embodiment 1-9. According to this embodiment, in the case that both order information 200 and material 100 are formed of digitized data, production processing section 300 simultaneously sends both order information 200 and a thumb nail image (being an image at low resolution) of material 100 to the site where both are to be used.

In the case that material 100 is digitized data of the picture image, it is possible to generate low resolution data and/or high compressed data from the digital data, after which production processing section 300 sends not only low resolution data and/or high compressed data but also order information 200 to the site where they are to be used. By sending low resolution data, it is possible to check image data of material 100 before processing, which is a merit in that the operation can be conducted more easily.

It is preferable that low resolution data and/or high compressed data is generated on a way to production processing section 300, which means that the generation is conducted at a shop where the order is taken from the customer, or at a way station of the delivery service.

(Embodiment 1-10)

In the communication network shown in a block diagram of FIG. 9, this embodiment shows the case in which plural order information 200 and material 100 are digitized image data, and after plural order information 200 are gathered, production processing section 300 sends plural order information 200 to the site where plural order information 200 are to be used.

The preferred embodiments have been described above, however, the embodiments of the present invention are not limited to the above descriptions. For example, in embodiments 1-1 through 1-9, it is preferable that plural order information 200 for each order are processed separately.

Further, in embodiment 1-10, it is preferable that plural order information 200 for each order are processed together. For the examples for processing them together, all files are processed together by an archiver (being TAR, that is Tape file ARchive), or the contents of each file are linked to be one file, both of which can be used.

Embodiments 2-1 through 2-2 relate to the process of a production processing section which establishes the production process of a product by utilizing the material and order information.

As described in the background of the present invention, in the case in which the production process of a product is simulated, it is essential how operators are assigned. Specifically, in the ordering of photographic products, there are many cases in which human dependent production processes such as layout processing and design processing are included in which special skill is required of operators. Consequently, unless operators are assigned considering the skill, it is not possible to appropriately simulate the production processes. Further, in the human dependent production process, since the final quality of a product varies depending on an operator, some customers occasionally request an operator, based on the final quality of products in the past. In such a case, it is necessary to assign operators and take into account the desire of the customers.

Consequently, in embodiment 2, when a production process to process orders comprising such a human dependent production process is simulated, information which assigns an operator for the production process for each customer (an operator assigning table), information which assigns processing time to an operator (a processing time assigning table), and information which assigns production process dependence (equipment dependence or human dependence) to the process, while taking into account of operator skill, the relationship between the customer and the operator, and the dependence (equipment dependence or human dependence) of each of the production processes are previously provided. With reference to these tables, it is possible to assign an operator for each of the production processes, whereby it is possible to more appropriately simulate the production process of products, whereby it is possible to more correctly calculate the production time and to prepare a more precise production schedule. Further, by assigning an operator to a customer, it is more possible to conduct the production control so that it is possible to provide finished products which satisfy the customer.

(Embodiment 2-1)

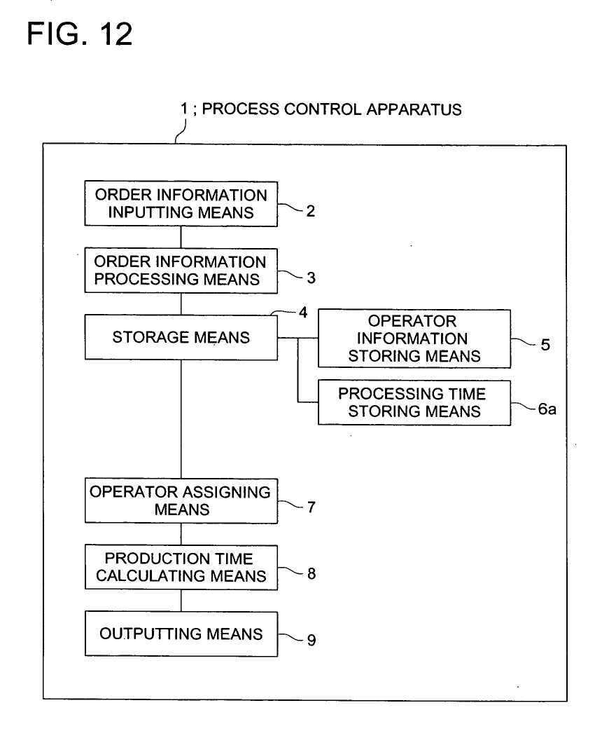

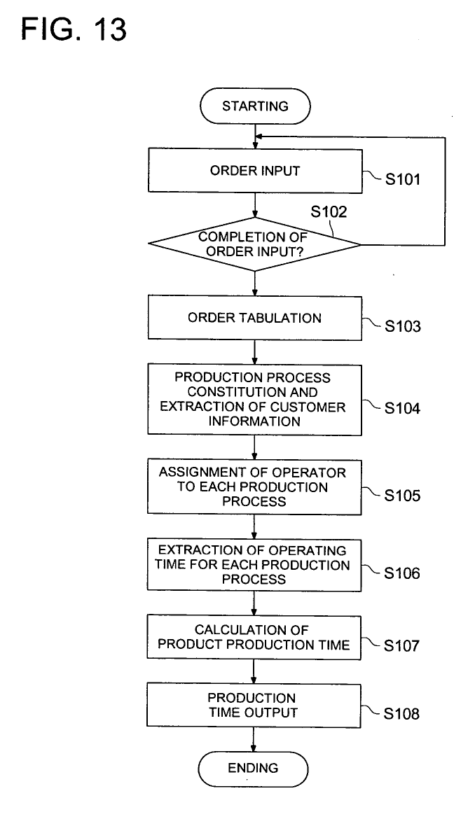

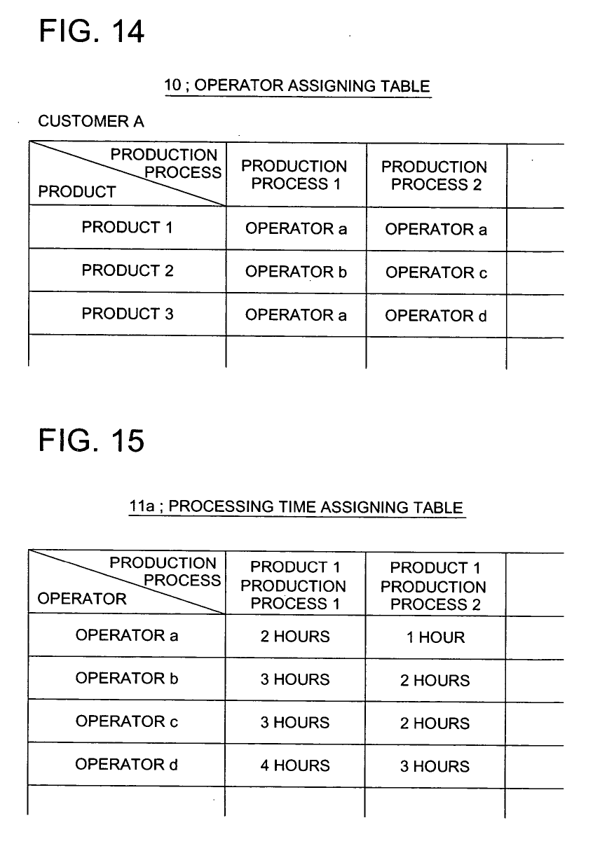

Initially, with reference to FIGS. 12-15, described are the process control methods and the process control programs related to embodiment 2-1 of the present invention. FIG. 12 is a block diagram showing the constitution of a process control apparatus related to the first example. FIG. 13 is a flow chart showing the steps of the production control of the present example. Further, FIGS. 14 and 15 are each a view showing an example of the constitution of the table used in the process control method of the present example. Incidentally, the present invention is used to manage the production control of products, and may individually be operated as a simulation apparatus or may be operated as a production apparatus of products while coupled with an order receiving apparatus and production equipment. However in the following description is a case in which the production control apparatus of the present invention is individually operated as a simulation apparatus.

As shown in FIG. 12, process control apparatus 1 of the present example comprises order information (information of work processes) inputting means 2 which inputs the information (hereinafter referred to as order information, i.e. working items) of the types and quantities of products and customers of the products; order information processing means 3 which analyzes order information, to constitute production processes, and extracts information (hereinafter referred to as customer identifying information) which identifies a customer from order information; storage means 4 which stores a table which is referred to during assignment processing, and production time calculation processing; operator assigning means 7 which assigns an operator for each of the production processes; production time calculating means 8 which calculates the necessary time to produce a product by extracting the processing time of each of the production processes and totaling them; and outputting means 9 which outputs the calculated production time. Storage means 4 comprises operator information storage means 5 which stores an operator assigning table in which for each customer, an operator is assigned for each of the production processes, and processing time information storage means 6a which stores a processing time assigning table in which the processing time for each of the production processes is assigned to an operator of each of the corresponding production processes.

Incidentally, the constitution in FIG. 13 exemplifies process control apparatus 1 of the present example. In addition to these means, other means such as an operation means may be provided. Further, operator assigning means 7 and production time calculating means 8 may be constituted as hardware in process control apparatus 1 or may be constituted as software and installed in process control apparatus 1.

Steps which output the production time for the input of order information while employing process control apparatus 1, constituted as above, will now be described with reference to the flow chart of FIG. 13 and the tables of FIGS. 14 and 15.

Initially, in step S101, information which identifies a customer and order information comprising the types and quantities of products are successively inputted employing order information inputting means 2 of process control apparatus 1.

Subsequently, when order inputting is completed in step S102, order information is totaled in step S103, employing order information processing means 3. Thereafter, in step S104, production processing to produce the product, identified by each part of order information inputted in step S104, is divided into each production process (for example, in the case of an order of photo postcards, a production process which reads image information of the photographic film strip provided by a customer; a production process which inputs text information described on the order slip; a production process to prepare the integrated data for the photo postcard while laying out image information and text information; and a production process to prepare the photo postcard based on the integrated data). In the case of production of a plurality of products, when the same production process(es) are employed, a production process is constituted so that a plurality of the products is collectively produced. Simultaneously, customer specifying information which identifies a customer to each of the products in the order information is extracted.

Subsequently, in step S105, an operator is assigned for each of the production processes, employing operator assigning means 7. At that time, in the present example, an operator is assigned to each of the production processes with reference to the operator assigning table for each operator, which has been stored in operator information storing means 5. The operator assigning table is constituted, for example, as shown in FIG. 14. Operators (in FIG. 14, operators “a”-“d”) are assigned while taking into account their specific skills, finished quality of the past products, and demands of the customers for each of the production processes (in FIG. 2, production processes 1 and 2) to produce each of the products (in FIG. 3, products 1-3) for each customer (in FIG. 3, customer A).

Reasons for preparing such operator assigning table 10 are as follows. In the case of non-human dependent orders (for example, development of photographic film strips and production of photographic prints), neither processing time nor finished quality differs even though the processing is performed by any operator. However, in the case, as for preparation of photo postcard, in which image information and text information are subjected to layout and a production process is included in which photographic images are designed through image processing such as cropping, processing time and finished quality differ due to the difference in skill of the operator. Consequently, when operators are not properly arranged, it occasionally occurs that the entire production processing for orders is delayed or customers are not satisfied with the final quality of products. Consequently, in the present example, in view of the special characteristics of products related to photography, operators are previously assigned to each of the production processes for each of the customers and is stored whereby the production process is appropriately simulated by making it possible to assign appropriate operators and the production processes are controlled to more satisfy the customer.

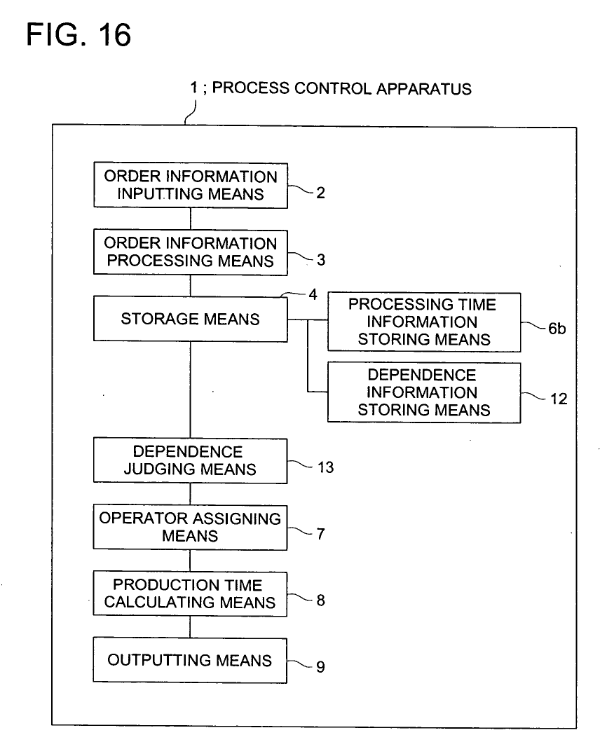

Subsequently, in step S106, by employing production time calculating means 8, the processing time of each of the production processes is extracted with reference to the processing time assigning table stored in processing time information storing means 6a. The time table is constituted, for example as shown in FIG. 16, and the processing time of each of the operators (in FIG. 5, operators “a”-“d”) is recorded for each of the production processes (in FIG. 5, production processes 1 and 2) to produce each specific product. For example, when operator “a” processes production processes 1 and 2 of product 1, 2 hours for production process 1 and 1 hour for production process 2 are extracted, respectively.

Subsequently, in step S107, the processing time of each of the production processes is integrated, whereby the total time required for production of a product is calculated. Further, when other combinations exist for the assignment of operators, the total time required for production of a product is also calculated in the same manner as above, and in step 108, the results are outputted employing outputting means 9.

As mentioned above, in the process control method of the present example, operator assigning table 10 which assigns an operator for each of the production processes for each of the customers and processing time assigning table 11a which assigns the processing time for each of the operators to each of the production processes, are stored in storage means 4, while paying attention to the operator's skill and the relationship between the customer and the operator. In operator assigning means 7, an operator who is suitable for processing each of the production processes is assigned with reference to operator assigning table 10. In production time calculating means 8, the processing time of each of the production processes is extracted with reference to processing time assigning table 11a and the necessary time for producing a product is calculated by totaling the extracted times. By so doing, even though an order is human-dependent, it is possible to appropriately simulate production control and in addition, to control the production process so that it is possible to provide finished products which please the customer.

(Embodiment 2-2)

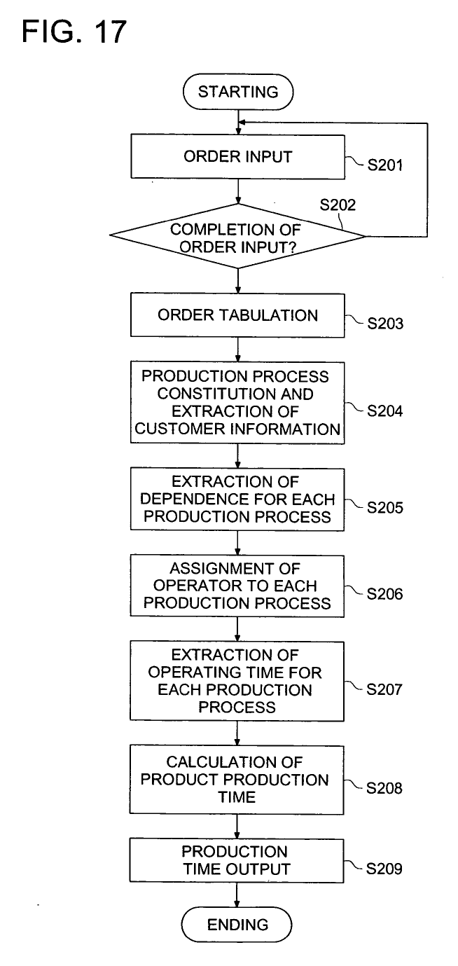

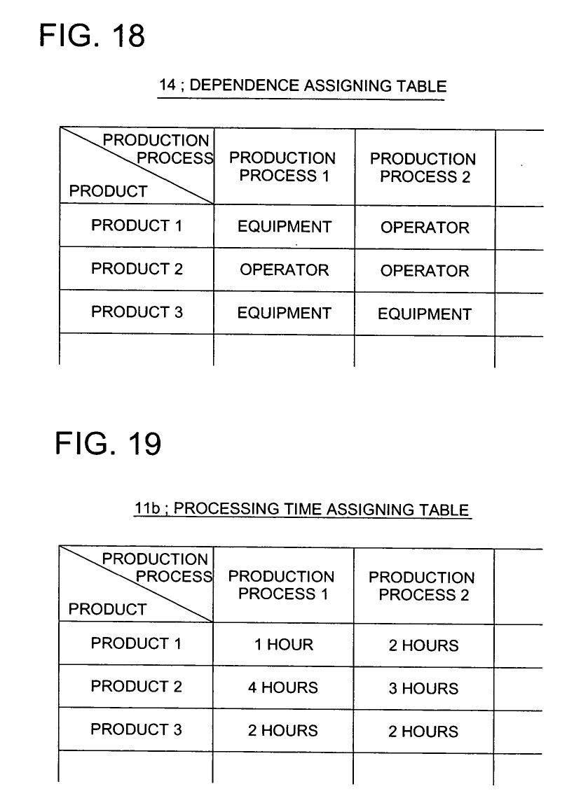

A process control method and a process control program related to embodiment 2-2 of the present invention will now be described with reference to FIGS. 16-19. FIG. 16 is a block diagram showing the constitution of a process control apparatus related to embodiment 2-2, while FIG. 17 is a flow chart showing the steps of the production control of the present example. Further, FIGS. 18 and 19 are each a view showing an example of the constitution of a table utilized in the process control method of the present example.

In the embodiment 2-1, described is the case in which an operator is assigned for each of the production processes for each of the customers. This method is effective when the relationship between the customer and the operator is compatible. However, it is not possible to previously prepare a table which assigns an operator to a customer. Consequently, in order to more flexibly simulate production processes, the present example is characterized in that judgment is made whether the processing time of each of the production processes depends on equipment or an operator, and necessary time to produce a product is calculated.

Specifically, as shown in FIG. 16, process control apparatus 1 of the present example comprises order information inputting means 2 which inputs order information, order information processing means 3 which processes order information to constitute production processes, storage means 4 which stores tables which are referred to in the dependence judgment process and production time calculation processing, dependence judging means 13 which determines the type of dependence (equipment dependence or human dependence) of each of the production processes, operator assigning means 7 which assigns an operator for each of the production processes, production time calculating means 8 which calculates the necessary time to produce a product while extracting the processing time for each of the production process and totals them, and outputting means 9 which outputs the calculated production time. Storage means 4 comprises processing time information storage means 6b which stores a processing time assigning table which assigns processing time to each of the production processes, and dependence information storage means 12 which stores a dependence assigning table which assigns dependence (equipment dependence or human dependence) to each of the production processes.

Incidentally, similarly to embodiment 2-1, the constitution of FIG. 16 exemplifies process control apparatus 1. In addition to these means, other means such as a display means or an operation means may be added. Further, dependence judgment means 13, operator assigning means 7, and production time calculating means 8 may be constituted in process control apparatus 1 as hardware, or may be constituted as software to be installed in process control apparatus 1.

Steps which output the production time of a product for the input of the order information, while employing process control apparatus 1 constituted as above, will be described with reference to the flow chart of FIG. 17 and the tables of FIGS. 18 and 19.

First, in the same manner as embodiment 2-1, in step S201, information to identify customers and information comprising the types and quantities of products are subsequently inputted employing order information inputting means 2 of process control apparatus 1.

Subsequently, after completing the input of the order in step S202, in step S203, order information is totaled employing order information processing means 3. In step S204, processing to produce products identified by each of the inputted order information is divided into each of the production processes. In the case of production of a plurality of products, when the same production process(es) are employed, processing is carried out so that the production processes are integrated, whereby production processes are constituted to collectively produce a plurality of the products.

Subsequently, in step S205, dependence of each of the production processes is judged utilizing dependence judging means 13. During that operation, in the present example, judgment is made whether each of the production processes is dependent on equipment or an operator with reference to the dependence assigning table previously stored in dependence information storing means 12. The dependence assigning table is constituted, for example, as shown in FIG. 18, and equipment dependence or human dependence (in FIG. 7, equipment or an operator) is set for each of the production processes (in FIG. 7, production processes 1 and 2) of each of the products (in FIG. 7, products 1-3), while considering whether the skills of a specific operator are required or not.

The reason to prepare the dependence assigning table 14 follows. In the case of a non-human dependent production process (for example, development of photographic film strips and production of photographic prints), it is possible to calculate processing time based on the processing capacity of the equipment. However, in the case such as preparation photo postcards which includes production processes such as layout of image information and text information and design of photographic images employing image processing such as cropping, it is not possible to calculate processing time based on the processing capacity of the equipment. Consequently, in the present example, in view of characteristics of work orders related to photography, each of the production processes used to produce ordered products is judged whether it is equipment dependent or human dependent. Thus it is possible to calculate the processing time while taking into account the kind of dependence, whereby, it makes it possible to more flexibly simulate the process control.

Subsequently, in step S206, an operator is assigned for each of the production processes utilizing operator assigning means 7. At that time, in the present example, for a human dependent process, a specific operator is assigned upon considering the operator's skills, while for an equipment dependent process, the operator listed in the previously prepared order is assigned, while, for example, considering the operator's load. Incidentally, when an operator is assigned for an operator dependent process, it is possible to assign the operator with reference to the previously prepared table which assigns an operator for each of the production processes, in the same manner as embodiment 2-1.

Subsequently, in step S207, the processing time of each of the production processes is extracted utilizing production time calculating means 8 with reference to the processing time assigning table stored in processing time information storing means 6b. The table is constituted, for example, as shown in FIG. 19, and the processing time is set for each of the production processes (in FIG. 8, production processes 1 and 2) of each of the products (in FIG. 8, products 1-3), based on equipment dependence or operator dependence. For example, when a production process is dependent on equipment, the processing time which has been calculated based on the processing capacity of the equipment is set, while when a production process is dependent on an operator, the processing time of a typical operator is set.

In step S208, the processing time of each of the production processes which has been extracted is totaled, whereby the necessary total time to produces the product is calculated. Further, when other than an operator assignment, combinations are present, the necessary total time is calculated in the same manner. In step S209, the results are outputted by output means 9.

As mentioned above, in the process control method of the present example, by paying attention whether each of the production processes is dependent on equipment or an operator, stored in storage means 4 are dependence assigning table 14 which assigns equipment dependence or human dependence of a production process to the production process and processing time assigning table 11b which assigns the processing time to each of the production processes. In dependence judging means 13, dependence of each of the production processes is judged with reference to dependence assigning table 14, and in operator assigning means 7, an operator possessing desired skills is assigned to the human dependent process. In production time calculating means 8, the processing time of each of the production processes is extracted based on the processing capacity of the equipment or the processing time of a typical operator, and the resulting processing time is totaled to calculate the necessary time to produce the products, whereby even though an order is human dependent, it is possible to appropriately simulate the process control.

For the best effect of the present invention, it is possible to provide a process control system wherein the amount of materials to be processed at a production processing site is researched beforehand, the working time of the equipment is studied, and the necessary manpower is reserved so that the production is performed most efficiently.

Further, the process control method and the process control program of the present invention result in the effects described below.

The effect of the present invention is that even in a production process which is dependent on an operator, it is possible to adequately simulate the production of products, whereby it is possible to correctly calculate the production time of those products and to prepare a precise production schedule.

The reasoning is as follows. Stored in a process control apparatus are a production process which is set for each customer and operator assigning information, and a production process and processing time assigning information for the production process. In an operator assigning means, an operator is assigned with reference to the operator assigning table which is set up taking into account the skill of the operator. In the production time calculating means, processing time is extracted with reference to the processing time assigning table and the production time of a product is calculated.

Further, stored in the process control apparatus are a production process and processing time assigning information, and a production process and equipment dependence or human dependence assigning information for the production process. In a dependence judging means, judgment of whether the processing time of each production process is dependent on equipment or an operator is made with reference to the dependence assigning table which shows the dependence of each of the production processes. In a production time calculating means, processing time is extracted with reference to the processing time assigning table which shows the set processing time taking into account the dependence for each of the production processes, and the production time of a product is then calculated.

Further, the second effect of the present invention makes it possible to control production process so that it is possible to provide a product which satisfies the customer.

The reasoning is as follows. During preparation of the operator assigning table which is referred to for assigning of an operator, assignment is made while taking onto account not only the skill of operators but also the relationship between the customer and the operator. As a result, the production process is controlled so that a product is prepared by the operator who is compatible with the customer.

What is claimed is:

1. A process control system, comprising:
a first place at which a customer places an order to produce an product from a material of the customer, by explaining an order information which relates to a production process of the product;
a first conveyance device to convey the material from the first place to the second place;
a second conveyance device to convey the order information from the first place to the second place;
a second place at which the product is produced from the material, based on the order information;
wherein the material and the order information are separately utilized to produce the product at the second place.

2. A process control system, comprising:
a first place at which a customer places an order to produce an product from a material of the customer, by explaining an order information which relates to a production process of the product;
a first conveyance means to convey the material from the first place to the second place;
a second conveyance means to convey the order information from the first place to the second place; and
a second place at which the product is produced from the material, based on the order information;
wherein the order information is utilized at the second place, before the material comes into a condition in which the product is produced from the material at the second place.

3. The process control system in claim 1, wherein the material is photographic film, photographic paper, or a medium on which digital data have been recorded.

4. The process control system in claim 1, wherein the order information comprises, at least
a type of the product to be produced from the material;
a quantity of the product to be produced;
information to identify the material;
information to identify the customer;
information to identify the first place; and
information about a delivery time of the product.

5. A process control method, comprising at least the steps of:
storing an operator assigning information in which, for each customer who orders a product, a production process to produce the product is assigned to an operator who performs processing of each of the production processes;
inputting an order information which includes information to identify the customer of the product, as well as information to identify the product; and
assigning the operator for each of the production processes which have been set based on the product identified by the order information with reference to the operator assigning information corresponding to the customer, identified by the order information.

6. The process control method, comprising at least the steps of:
storing the operator assigning information in which, for each customer of a product, the production process to produce the product is assigned to an operator who performs processing of each of the production processes, as well as a processing time assigning information in which necessary time to perform processing of each of the production processes is assigned to each operator of the production process;
inputting the order information which includes information to identify the customer, as well as information to identify the product;
assigning an operator to each of the production processes which have been set based on the product identified by the order information with reference to the operator assigning information corresponding to the customer, identified by the order information;
calculating necessary production time to produce the product while extracting the processing time of each of the production processes and totaling the production time, with reference to the processing time assigning information; and
outputting the overall production time.

7. The process control method comprising at least the steps of:
storing a dependence assigning information which assigns production process which produce a product to dependence on whether the processing time of production is dependent on an equipment or the operator;
inputting the order information which includes information to identify the customer who orders the product, as well as information to identify the product;
judging whether the processing time of each of the production processes, which have been set based on the product identified by the order information, is dependent on the equipment or the operator, with reference to the dependence assigning information; and
assigning the operator to each of the production processes which have been set based on the product identified by the order information, with reference to result of the judgment.

8. The process control method comprising at least the steps of:
storing the dependence assigning information which assigns dependence on whether the processing time of production processes and each production process which produce a product are dependent on the equipment or the operator, as well as the processing time assigning information which assigns the processing time to the production process;
inputting the order information which includes information to identify the customer who orders the product, as well as information to identify the product;
judging whether the processing time of each of the production processes, which have been set based on the product identified by the order information, is dependent on the equipment or the operator, with reference to the dependence assigning information;
assigning an operator to each of the production processes, which have been set based on the product identified by the order information, with reference to results of the judgment;
calculating the necessary production time to produce the product while extracting the processing time which is set based on the production processing capacity of the equipment in the case in which the processing time is dependent on equipment, and extracting the processing time which is set based on the production processing capacity of a typical operator in the case in which the processing time is dependent on the operator, with reference to the processing time assigning information, and totaling the production processing times, and
outputting the production time.

9. The process control method in claim 5, wherein either the operator assigning information or the dependence assigning information is set based on the skill of the operator, or the relationship between the customer and the operator.

10. A process control program wherein a computer is allowed to function as at least the means of:
inputting an order information which includes information to identify a customer who orders a product, as well as information to identify the product; and
assigning an operator to each of the production processes which have been set based on the product identified by the order information, with reference to an operator assigning information which assigns an operator to each of the production processes to produce the product, which has been stored for each of the customers.

11. The process control program wherein the computer is allowed to function as at least the means of:
inputting the order information which includes information to identify the customer who orders the product, as well as information to identify the product;
assigning the operator to each of the production processes which have been set based on the product identified by the order information, with reference to the operator assigning information which assigns the operator to each of the production processes to produce the product which has been stored for each of the customers;
calculating necessary production time to produce the product while extracting the processing time of each of the production processes with reference to previously stored processing time assigning information which assigns the operator to the necessary time to process each of the production processes and totaling the production processing times; and
outputting the production time.

12. The process control program wherein the computer is allowed to function as at least the means of:
inputting the order information which includes information to identify the customer who orders the product, as well as information to identify the product;
judging whether the processing time of each of the production processes, which have been set based on the product identified by the order information, is dependent on an equipment or the operator, with reference to the previously stored dependence assigning information which assigns each production process which produce the product to dependence on whether the processing time of production processes is dependent on the equipment or the operator; and
assigning the operator for each of the production processes which have been set based on the product identified by the order information with reference to results of the judgment.

13. The process control program wherein the computer is allowed to function as at least the means of:
inputting the order information which includes information to identify the customer who orders the product, as well as information to identify the product;
judging whether the processing time of each of the production processes, which have been set based on the product identified by the order information, is dependent on the equipment or the operator, with reference to the previously stored dependence assigning information which assigns each production process which produce the product to dependence on whether the processing time of production processes is dependent on the equipment or the operator;
assigning the operator to each of the production processes which have been set based on the product identified by the order information, with reference to results of the judgment;
calculating the necessary production time to produce the product while extracting the processing time which is set based on the processing capacity of the equipment in the case in which the processing time is dependent on the equipment, and extracting the processing time which is set based on the processing capacity of a typical operator in the case in which the processing time is dependent on the operator, with reference to the previously stored processing time assigning information which assigns the processing time to the production process and totaling the individual processing times; and
outputting the production time.

14. The process control program in claim 10, wherein either the operator assigning information or the dependence assigning information is set based on the skill of the operator, or the relationship between the customer and the
